(19) United States
(12) Patent Application Publication
(10) Pub. No.: US 2006/0078189 A1
(43) Pub. Date: Apr. 13, 2006

(54) Method and apparatus for inspection

(76) Inventors: Naoki Hosoya, Yokohama (JP); Takashi Hiroi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/196,255

(22) Filed: Aug. 4, 2005

(30) Foreign Application Priority Data
Sep. 29, 2004 (JP) 2004-283015

(51) Int. Cl. G06K 9/00

(52) U.S. Cl. 382/149

(57) ABSTRACT

To make it possible to produce inspection conditions for optimizing various inspection conditions by extracting DOIs efficiently and instructing them reliably in a state where a few DOIs are hidden among a large number of nuisances. According to the present invention, a semiconductor wafer is inspected, images of defects detected by the inspection are shown on a screen, and an input interface is provided through which any given defect can be selected from among the defects whose images are shown. The inspection is conducted in such a way that the inspection conditions are adjusted to enhance capabilities for detecting the defect instructed by a user.

### BACKGROUND OF THE INVENTION

1. Field of the Invention

The present invention relates to a technology for inspecting semiconductor wafers. In particular, it relates to a method and an apparatus which can be applied effectively to various condition-producing methods for defect judgment, defect image processing, defect classification, etc. of the inspection apparatus.

2. Description of the Prior Art

As electronic products are getting smaller and having more functionality, semiconductors are also becoming considerably smaller, and new semiconductor products are being introduced on the market one after another. On the other hand, in semiconductor manufacturing processes, inline defect inspections of the semiconductor wafers are conducted. As a semiconductor becomes smaller, a defect causing a failure in a device, namely, a defect of interest (DOI) becomes smaller. To cope with this, more and more highly sensitive defect inspections are being conducted. As a result, many unnecessary defects (nuisances) such as microscopic asperities on the wafer surface are also detected, causing a small number of DOIs being hidden among a large number of nuisances.

Accordingly, it becomes important to reliably detect the DOIs alone with respect to a new device. In order to achieve it, a condition-producing method that can properly and easily set various inspection conditions for defect judgment, defect image processing, defect classification, etc. of an inspection apparatus is indispensable.

For example, U.S. Pat. No. 6,178,257 discloses an inspection apparatus comprising a classifier capable of obtaining defect images and classifying them by using data stored in advance in a database. Further, for example, JP2003-515942T discloses a data processing system wherein a user instructs how to classify defects and the system sets the classification conditions and classifies them based on the instruction and shows the classified result.

A method according to the above U.S. Pat. No. 6,178,257 does not show whether or not the classification of defects is instructed in advance. In order to detect a DOI without fail, it is necessary to instruct the DOI reliably. However, it is not easy to find a few DOIs alone among a lot of nuisances and instruct them. What actually happens is that either a user is forced to check all the defects one by one and instruct them or, at the result of instructing some of the defects only, the DOI is missed and optimization of the inspection conditions cannot be achieved.

Also, according to the above JP2002-515942T, a user is supposed to instruct how to classify defects. However, a specific procedure for the instruction is not shown, either.

### SUMMARY OF THE INVENTION

The present invention relates to a method and an apparatus for inspection which enable inspection-condition producing to optimize various inspection conditions for defect judgment, defect image processing, defect classification, etc. by extracting DOIs efficiently and instructing them reliably even where a few DOIs are hidden among a large number of nuisances in a defect inspection.

Namely, according to the inspection method of the one aspect of the present invention, a semiconductor wafer is inspected and one or more images of the defects detected in the inspection are shown on a screen. A user selects one or more DOIs from among the shown defects. By using the selected defect as a reference, indicators are given to other defects, and one or more images of the defects to which indicators are given are shown on the screen. By referencing indicators, the user instructs one or more DOIs from among the defects shown. Optimum values of various inspection conditions of the inspection apparatus for defect judgment, defect image processing, defect classification, and so on are calculated so that the selection ratio of the instructed defect will be higher. The obtained optimum values are set in an inspection recipe, and the inspection is conducted hereafter according to the optimum inspection conditions thus set.

According to the aspect of the invention, when the user select on DOI from among the defect images shown on the screen, indicators are given to all other defects by using such a DOI as a reference. Therefore, by referencing the indicators, a defect whose image feature is similar to the previously selected DOI can easily be extracted. Accordingly, it becomes possible to instruct DOIs efficiently and reliably. Further, since DOIs can reliably be instructed, it becomes possible to optimize various inspection conditions for defect judgment, defect image processing, defect classification, and so on of the inspection apparatus. Further, since the inspection can be conducted with optimum inspection conditions, even an ordinary user can make the most of capabilities of the apparatus to detect DOIs like an expert does.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 shows an example of a DOI search screen;

FIG. 2 shows an example of a DOI search screen 2;

FIG. 3 shows an example of a wafer reference screen;

FIG. 4 shows an example of a wafer reference screen 2;

FIG. 5 shows an example of an album referencing screen;

FIG. 6 shows an example of another album reference screen;

FIG. 7 shows another example of an album reference screen;

FIG. 8 shows still another example of an album reference screen;

FIG. 9 shows an example of a wafer select screen;

FIG. 10 shows an example of prescribed processing for dividing defects into groups;

FIG. 11 shows an example of prescribed processing for dividing defects into groups;

FIG. 12 shows an example of a DOI extract screen;

FIG. 13 shows another example of a DOI extract screen;

FIG. 14 shows an example of a procedure of an inspection method including producing inspection conditions;

FIG. 15 shows an example of a configuration of an inspection apparatus;

FIG. 16 shows an example of a detailed configuration of a defect judging section;

FIG. 17 shows another example of a detailed configuration of a defect judging section;

FIG. 18 shows still another example of a detailed configuration of a defect judging section; and

FIG. 19 shows an example of prescribed processing for automatically adjusting conditions.

### DESCRIPTION OF THE PREFERRED EMBODIMENTS

Now, referring to the drawings, embodiments of the present invention will be described.

### Embodiment 1

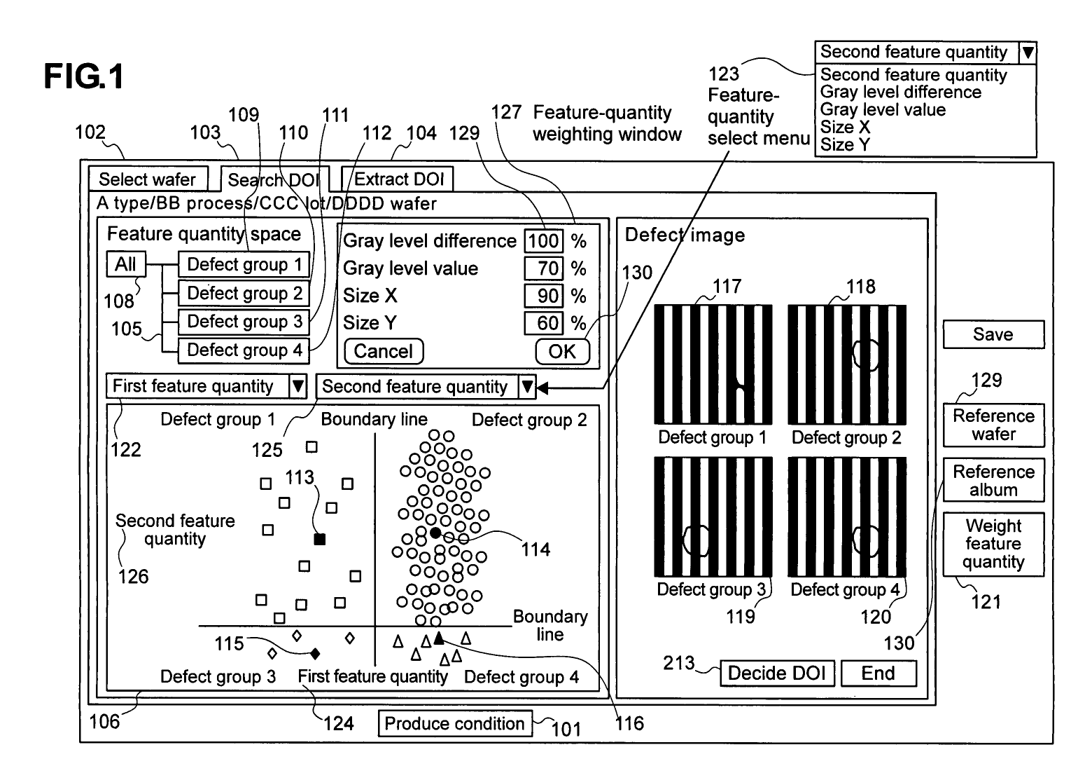

FIG. 1 shows an example of a DOI search screen which is one of the screens provided by a user interface for producing inspection conditions according to the present invention. When a condition producing button 101 on the screen is clicked, the DOI search screen is shown. There are a wafer select tab 102, a DOI search tab 103, and a DOI extract tab 104 on the screen. When the wafer select tab 102 is clicked, the wafer select screen is shown.

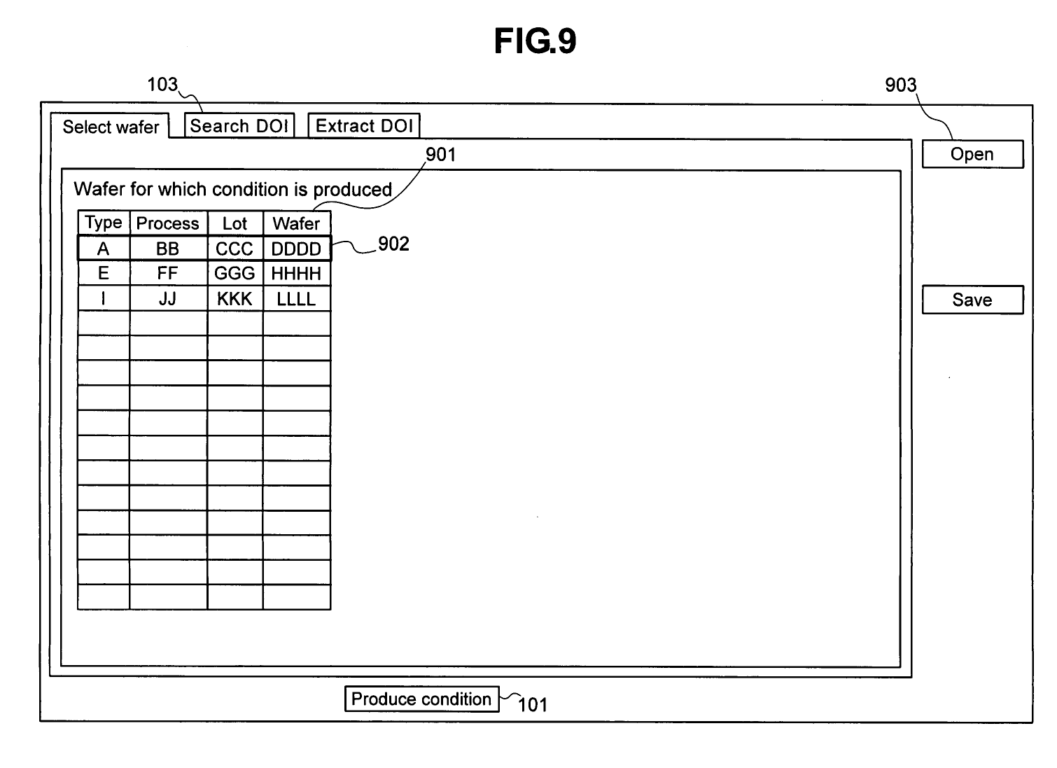

FIG. 9 shows an example of the wafer select screen. Shown on the screen is a list 901 of semiconductor wafers selectable as subjects for which conditions are made. On the list 901, information about one wafer is shown on each line. The wafer information shown includes a type name, a process name, a lot name, a wafer name, and so on. It is assumed that a wafer to be shown is inspected in advance by an inspection apparatus, an image of the portion which is judged as a defect in the defect judgment is extracted, a feature quantity of an image of each defect is calculated by image processing, and the feature quantity together with the above wafer information are inputted to the user interface. When a line of a wafer for which inspection conditions are to be made, namely, A type BB process CCC lot DDDD wafer 902 in FIG. 9, is clicked and an open button 903 is clicked, the wafer for which the inspection conditions are made is confirmed. When the DOI search tab 103 is clicked, the DOI search screen (FIG. 1) is shown.

All the defects 108 are divided into a defect group 1 109, a defect group 2 110, a defect group 3 111, and a defect group 4 112, and shown as a defect-group division tree 105. Further, each of the defect group 1 109, defect group 2 110, defect group 3 111, and defect group 4 112 is plotted in a feature-quantity space diagram 106. A representative defect 1 113, a representative defect 2 114, a representative defect 3 115, and a representative defect 4 116 of the respective defect groups are determined by prescribed processing and are shown in the feature-quantity space diagram 106. Further, a defect image 1 117, a defect image 2 118, a defect image 3 119, and a defect image 4 120 of the respective representative defects are shown. A user checks each representative defect and determines a defect group which may include a DOI. For example, if the user determines that the DOI is included in the defect group 1, he or she double-clicks the defect image 1 117. As a result, a DOI select screen 2 is shown.

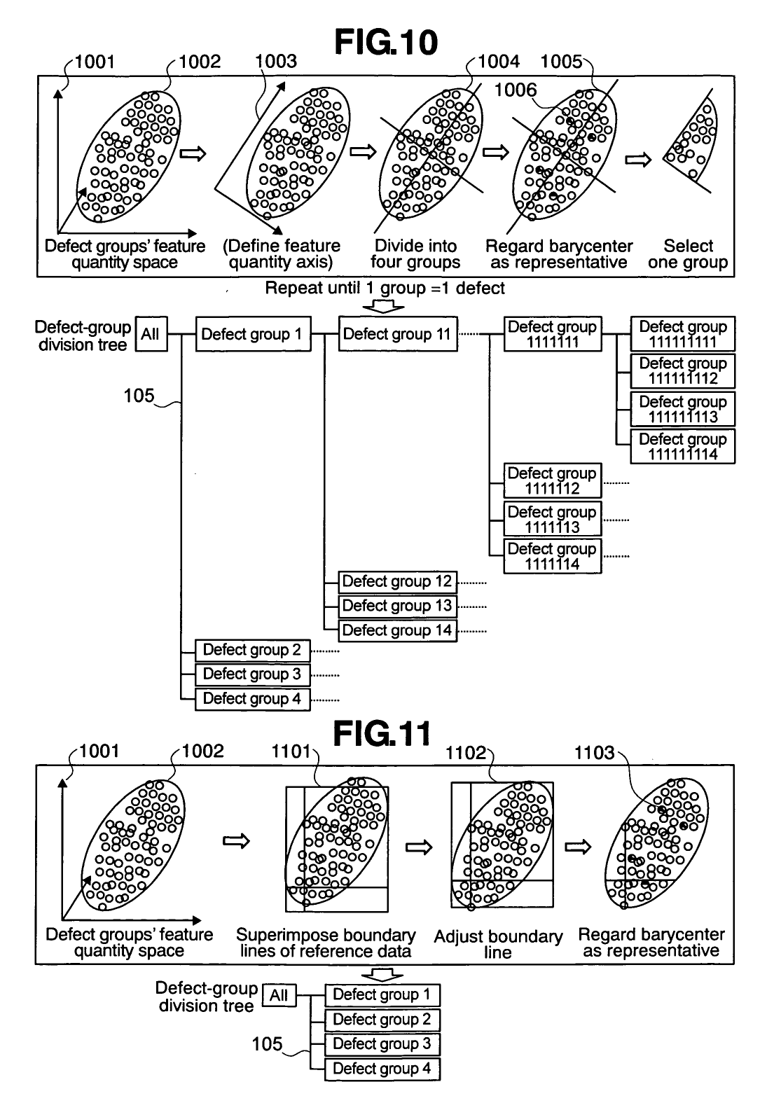

FIG. 10 shows an example of prescribed processing for dividing defects into groups and determines a representative defect. Since feature quantities for all the defects are given in advance, it is possible to plot all the defects 1002 in a feature quantity space 1001. Two feature quantities, for example, are selected from among the given feature quantities and a feature quantity plane 1003 defined by them is set. The two feature quantities maybe selected, for example, in the order of greater variance. Alternatively, an axis with grater variance may be defined by performing a quadrature (orthogonalized) (orthogonal) projection using a known main component analysis. With respect to these two feature quantities, defects are each divided into two groups, namely, four defect groups 1004. When dividing the defects into two groups, a known discrimination analysis, for example, may be used. Alternatively, a known clustering method such as K-means method may be used to divide defects into groups. Also, the number of groups is not limited to four, and it may be any given number. The defect nearest to a barycenter of the defect group 1005 after division is regarded as its representative defect 1006. The representative defect is not necessarily the one nearest to the barycenter, and it may be a defect nearest to the center. Alternatively, it may be determined by other methods. With respect to each of the defect group 1005 after division, the above processing is repeated until one defect is left in the defect group. With such processing, the defect-group division tree 105 is made.

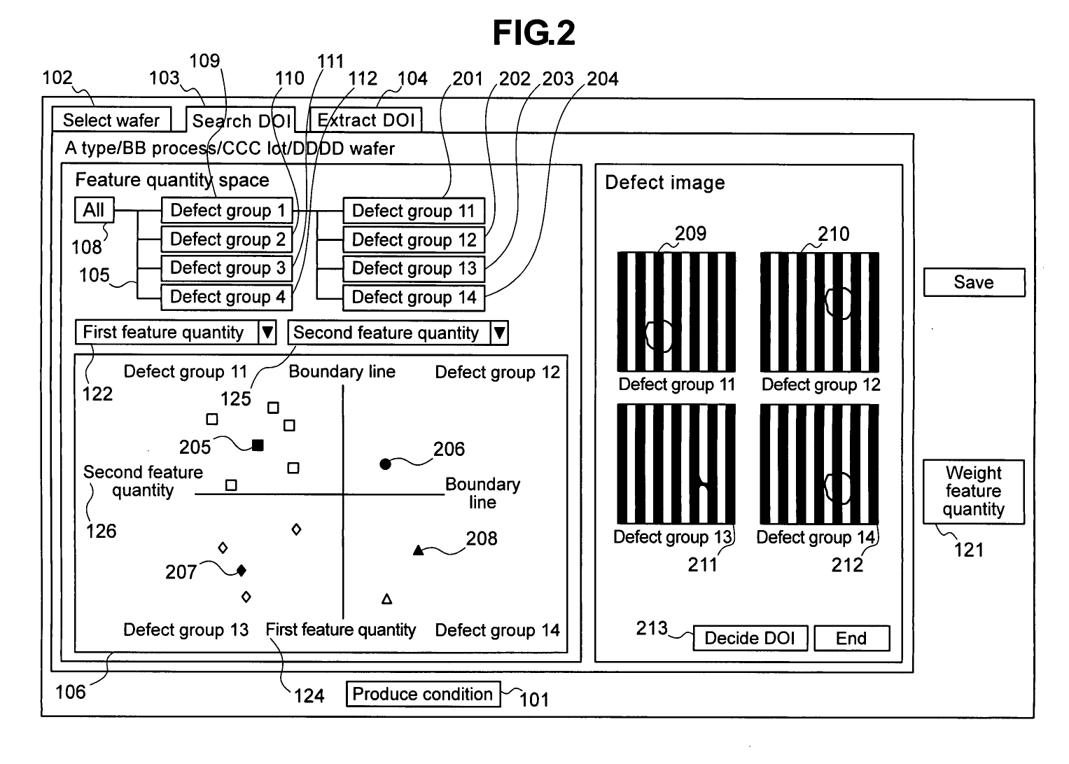

FIG. 2 shows an example of the DOI select screen 2. The defect group 1 109 is divided into a defect group 11 201, a defect group 12 202, a defect group 13 203, and a defect group 14 204 by prescribed processing and shown as a defect-group division tree 105. Further, respective defects of the defect group 11 201, defect group 12 202, defect group 13 203, and defect group 14 204 are plotted in the feature-quantity space diagram 106. A representative defect 11 205, a representative defect 12 206, a representative defect 13 207, and a representative defect 14 208 of respective defect groups are determined by prescribed processing and shown in the feature-quantity space diagram 106. Further, a defective image 11 209, a defective image 12 210, a defective image 13 211, and a defective image 14 212 of the respective representative defects are shown. The user checks each representative defect and determines a defect group which may include a DOI. If one of the representative defects is the DOI, the user selects it and clicks a DOI decide button 213. The selected defect is recorded as the DOI.

Further, on the DOI search screen (FIG. 1) and DOI search screen 2 (FIG. 2), a first feature-quantity button 122 and a second feature-quantity button 125 may be provided. When the first feature-quantity button 122 is clicked, a feature-quantity select menu 123 is shown. When a feature quantity is selected from the feature-quantity select menu 123, the feature quantity is shown on the horizontal axis 124 of the feature quantity space diagram 106. Similarly, when the second feature-quantity button 125 is clicked, the feature-quantity select menu 123 is shown. When a feature quantity is selected from the feature-quantity select menu 123, the feature quantity is shown on the vertical axis 126 of the feature-quantity space diagram 106.

Further, a feature-quantity weight button 121 may be provided in the DOI search window (FIG. 1) and DOI search window 2 (FIG. 2). When the feature-quantity weight button 121 is clicked, the feature-quantity weight window 127 is shown. In the feature-quantity weight window 127, a weight entry field 128 for each feature quantity is provided. The user enters a weighting value in the weight entry field 128 and clicks an OK button 130. The weighting value thus entered is used when defects are divided by prescribed processing.

Further, on the DOI search screen (FIG. 1), a wafer reference button 129 may be provided. When the wafer reference button is clicked, a wafer referencing screen is shown.

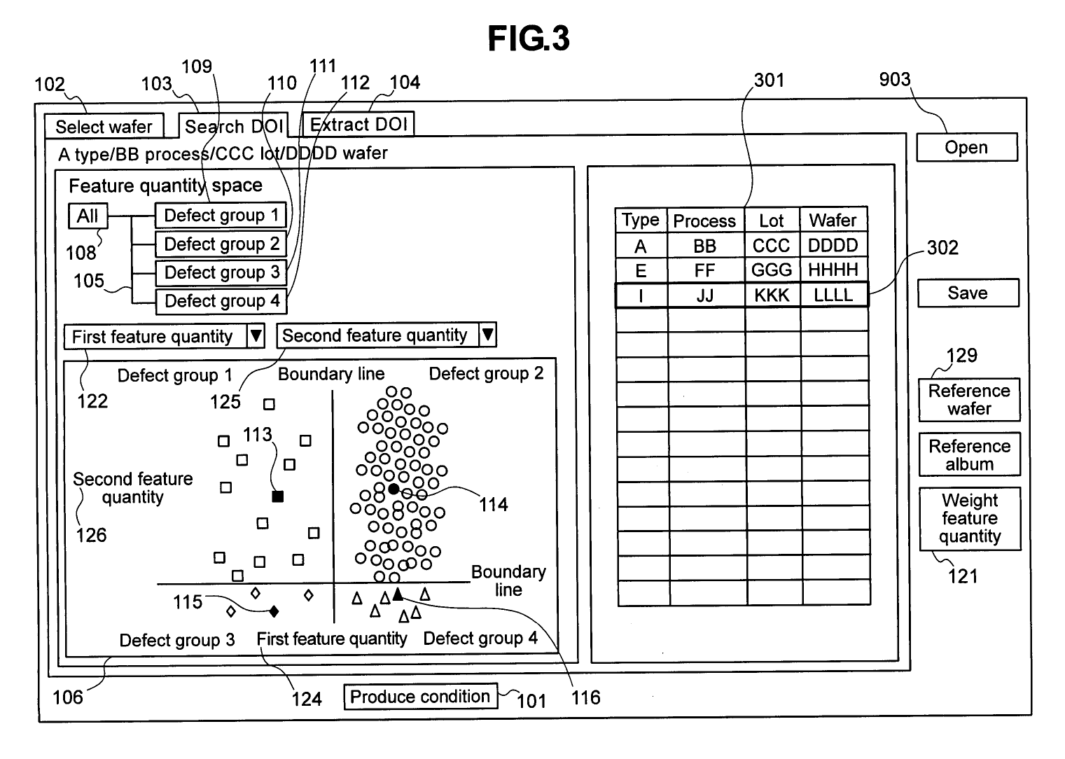

FIG. 3 shows an example of the wafer reference screen. On the screen, a list 301 of semiconductor wafers that can be selected as wafers to be referenced is shown. Information about one wafer is shown on each line of the list 301. Information about a wafer to be shown includes a type name, a process name, a lot name, and a wafer name. It is assumed that the wafer to be shown is inspected in advance by an inspection apparatus, an image of its portion which is judged as a defect by defect judgement is extracted, a feature quantity of the image of each defect is calculated by image processing, a DOI is extracted, and the feature quantity and extracted DOI are inputted to a user interface together with the wafer information described above. When a line of a wafer to be referenced (I type JJ process KKK lot LLLL wafer 302, in FIG. 3) is clicked, and an open button 903 is clicked, a wafer to be referenced is confirmed and a wafer reference screen 2 is shown.

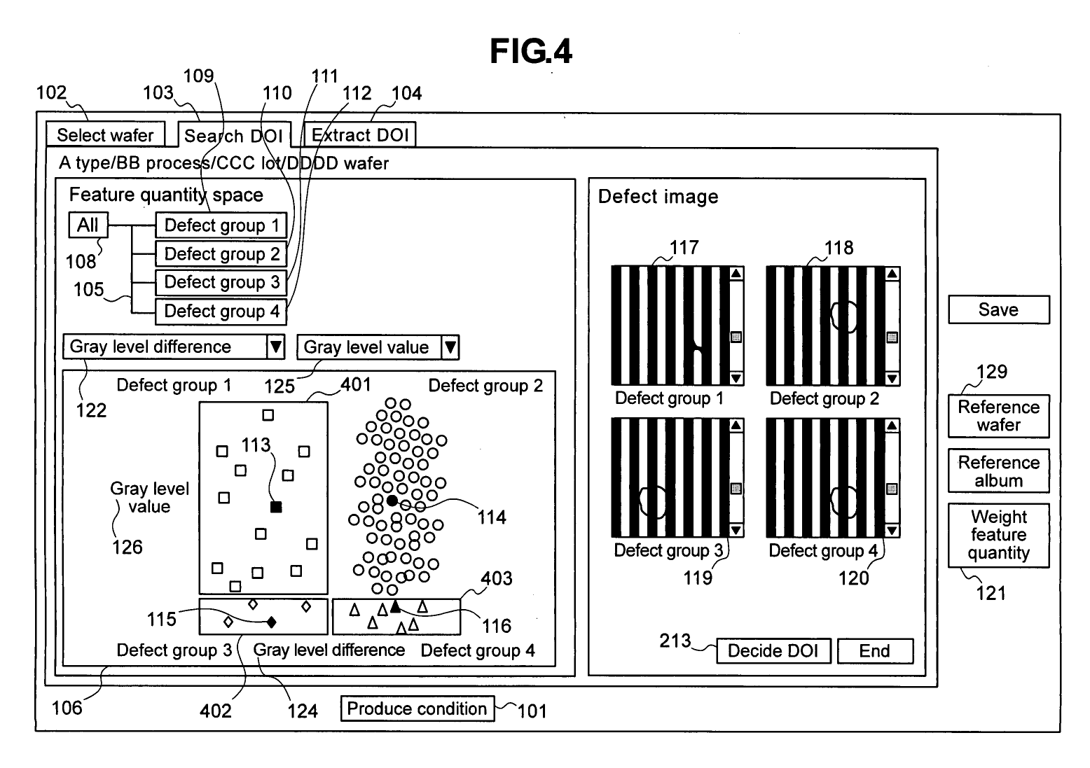

FIG. 4 shows an example of the wafer reference screen 2. All the defects 108 are divided into a defect group 1 109, a defect group 2 110, a defect group 3 111, and a defect group 4 112, and shown as a defect-group division tree 105. Further, defects of the defect group 1 109, defect group 2 110, defect group 3 111, and defect group 4 112 are plotted in the feature-quantity space diagram 106. A boundary line 1 401, a boundary line 2 401, and a boundary line 3 403 of respective defect groups are shown in the feature-quantity space diagram 106. Further, a defect image 1 117, a defect image 2 118, a defect image 3 119, and a defect image 4 120 of respective defect groups are shown. It is possible to scroll each defect image, and the user selects a DOI by checking each defect image and clicks a DOI decide button 213. The selected defect is recorded as the DOI.

FIG. 11 shows another example of prescribed processing for dividing defects into groups and determining a representative defect. The feature quantities about all the defects are given in advance. Therefore, all the defects 1002 can be plotted in the feature-quantity space 1001. A boundary area 1101 of the DOI of the referenced wafer given is superimposed over the feature-quantity space 1001. If the boundary area of the DOI and the distribution area of all the defects are not aligned, the boundary area of the DOI is adjusted. Being based on the boundary area 1102 after the adjustment, all the defects are divided into defect groups. The defect nearest to the barycenter of a defect group after division is regarded as a representative defect 1103 of the defect group. A defect-group division tree 105 is determined.

Further, in the DOI search screen (FIG. 1), an album reference button 130 may be provided. When the album reference button 130 is clicked, an album reference screen is shown.

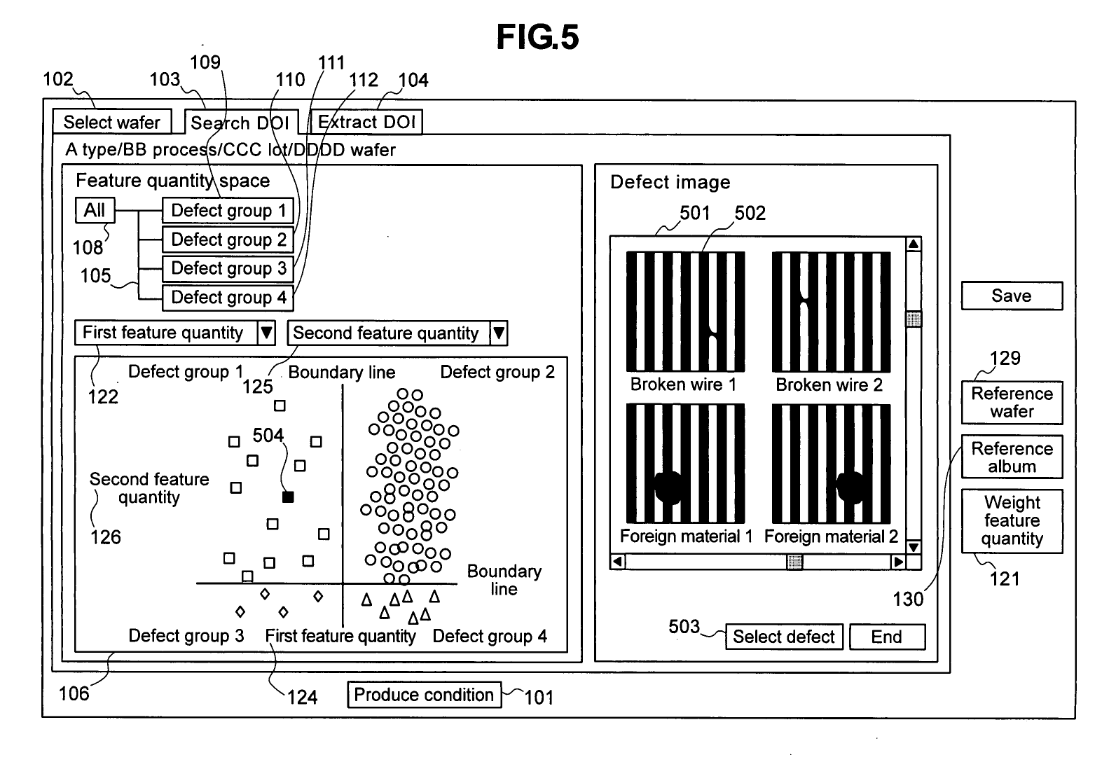

FIG. 5 shows an example of the album reference screen. On the screen, a defect image 501 that can be selected as a subject for album referencing is shown. It is assumed that the defect to be shown is inspected in advance by the inspection apparatus, an image of the portion judged as an defect by the defect judgment is extracted, a feature quantity of the image of each defect is calculated by image processing, extracted as a DOI, and the defect image and feature quantity are inputted to the user interface. When the image of the defect for which an album is referenced (a broken wire 1 502, in FIG. 5) is clicked and a defect select button 503 is clicked, a subject defect of the album referencing is confirmed and the subject defect 504 is plotted in the feature-quantity space diagram 106. In the same way as described above, the user checks defect groups whose subject defect 504 is plotted and its representative defect, and determines the defect group which may include a DOI. Then, the user double-clicks a defect image corresponding such a defect group. As a result, the DOI select screen 2 (FIG. 2) is shown. By checking each representative defect, the user determines a defect group which may include a DOI. If one of the representative defects is the DOI, the user selects it and clicks the DOI decide button 213. The selected defect is recorded as the DOI.

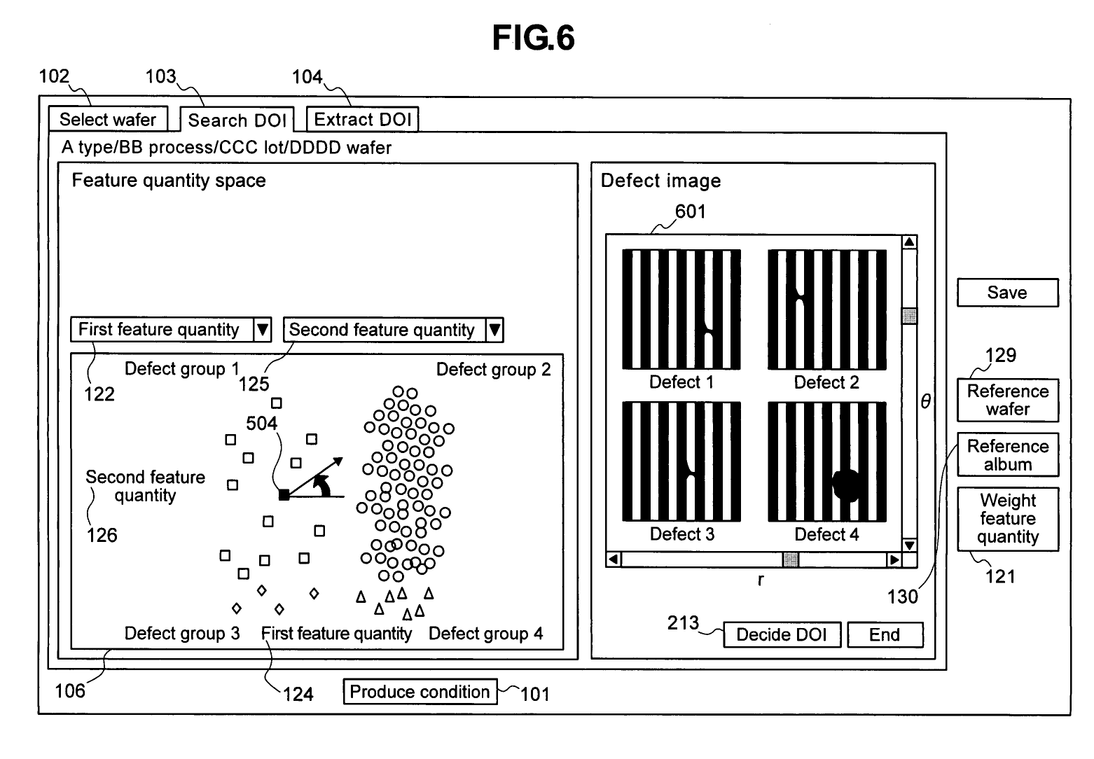

FIG. 6 shows another example of the album reference screen. On the screen of FIG. 5, defect images 501 that can be selected as subjects for album referencing are shown. It is assumed that the defect to be shown is inspected in advance by the inspection apparatus, an image of the portion which is judged as a defect by the defect judgment is extracted, the feature quantity of the image of each defect is calculated by image processing and extracted as a DOI, and the defect image and feature quantity are inputted to the user interface. When an image of the defect for which album referencing is to be conducted (a broken wire 1 502, in FIG. 6) is clicked and the defect select button 503 is clicked, the subject defect for album referencing is confirmed and the screen of FIG. 6 is shown. The subject defect 504 is plotted in the feature-quantity space diagram 106. All the defects are plotted in the feature-quantity space diagram. All the defects are sorted in the rθ coordinate system by using the subject defect 504 as a reference, and the defect image 601 is shown. The defect image can be scrolled in the rθ directions. The user selects a DOI by checking each defect image, and clicks the DOI decide button 213. The selected defect is recorded as the DOI.

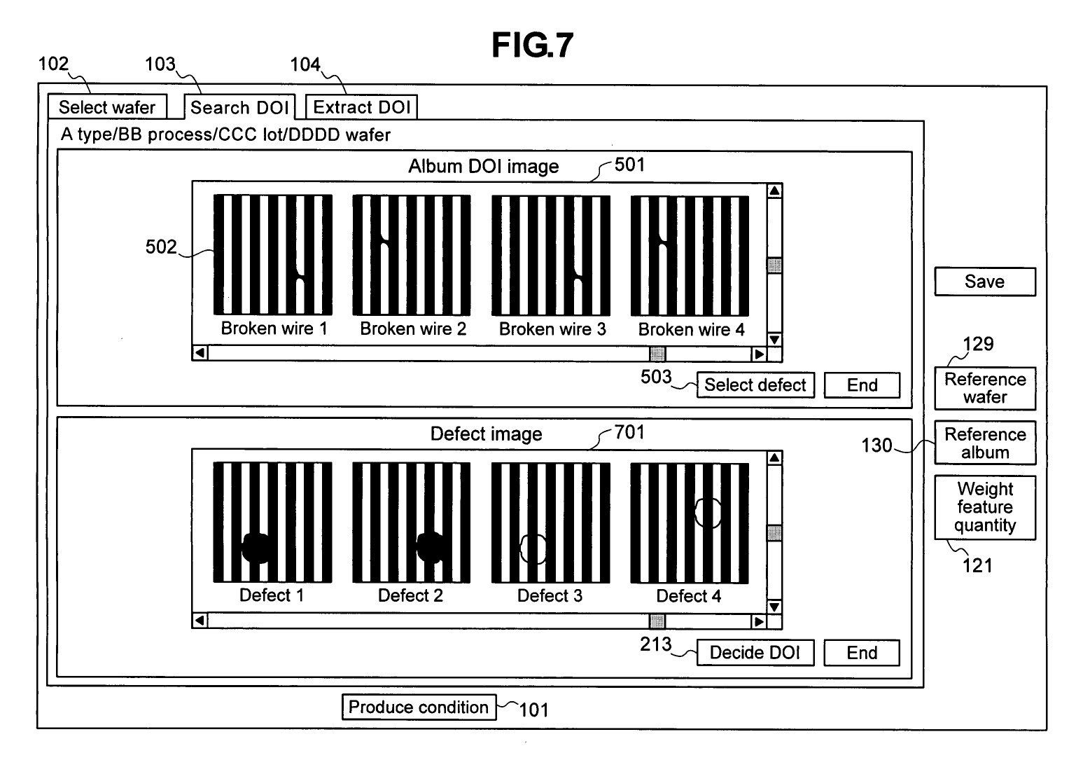

FIG. 7 shows another example of album referencing. On the screen, a defect image 501 which can be selected as a subject for album referencing is shown. It is assumed that the defect to be shown is inspected in advance by the inspection apparatus, an image of a portion which is judged as a defect by the defect judgment is extracted, a feature quantity of the image of each defect is calculated by image processing, extracted as a DOI, and both the defect image and feature quantity are inputted to the user interface. When the image of the defect for which album referencing is to be conducted (a broken wire 1 502, in FIG. 7) is clicked and the defect select button 503 is clicked, a subject defect for album referencing is confirmed. Using the subject defect as a reference, all the defects are arranged according to the closeness to the subject defect in the feature quantity space, and the defect image 701 is shown. The defect image can be scrolled, and the user selects a DOI by checking each defect image and clicks the DOI decide button 213. The selected defect is recorded as the DOI.

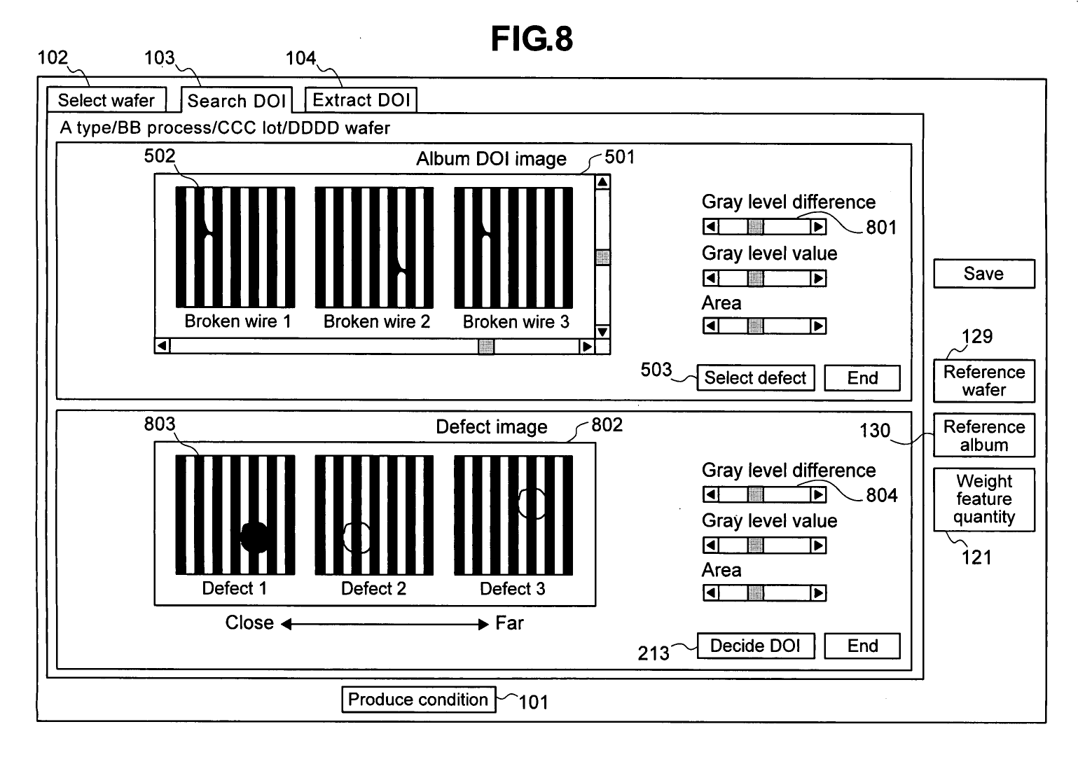

FIG. 8 shows another example of album referencing. A defect image 501 which can be selected as a subject for album referencing is shown on the screen. It is assumed that the defect to be shown is inspected in advance by the inspection apparatus, an image of a portion which is judged as a defect by defect judgment is extracted, a feature quantity of the image of each defect is calculated by image processing, extracted as a DOI, and the defect image and feature quantity are inputted to the user interface. When an image of the defect for which album referencing is conducted (a broken wire 1 502, in FIG. 8) is clicked and the defect select button 503 is clicked, a subject defect for album referencing is confirmed. Each feature quantity of the subject defect is shown on a feature quantity display bar 801. Using the subject defect as a reference, defects are arranged according to the closeness to the subject defect in the feature quantity space and the defect image 802 is shown. Further, each feature quantity of the defect 803 at the left end of the defect image 802 is shown on the feature-quantity display bar 804. The user can change the feature quantity on the feature-quantity display bar 804. Using the changed feature quantity as a reference, defects are renewed and arranged according to the closeness to the subject defect in the feature quantity space, and the defect image 802 is also renewed and displayed. The user selects a DOI by checking each defect image and clicks the DOI decide button 213. The selected defect is recorded as the DOI.

When the DOI selection is over, the DOI is extracted. When a DOI extract tab 104 is clicked on the DOI search screen (FIG. 1), DOI search screen 2 (FIG. 2), wafer reference screen 2 (FIG. 4), and album reference screens (FIGS. 5 to 8), a DOI extract screen is shown.

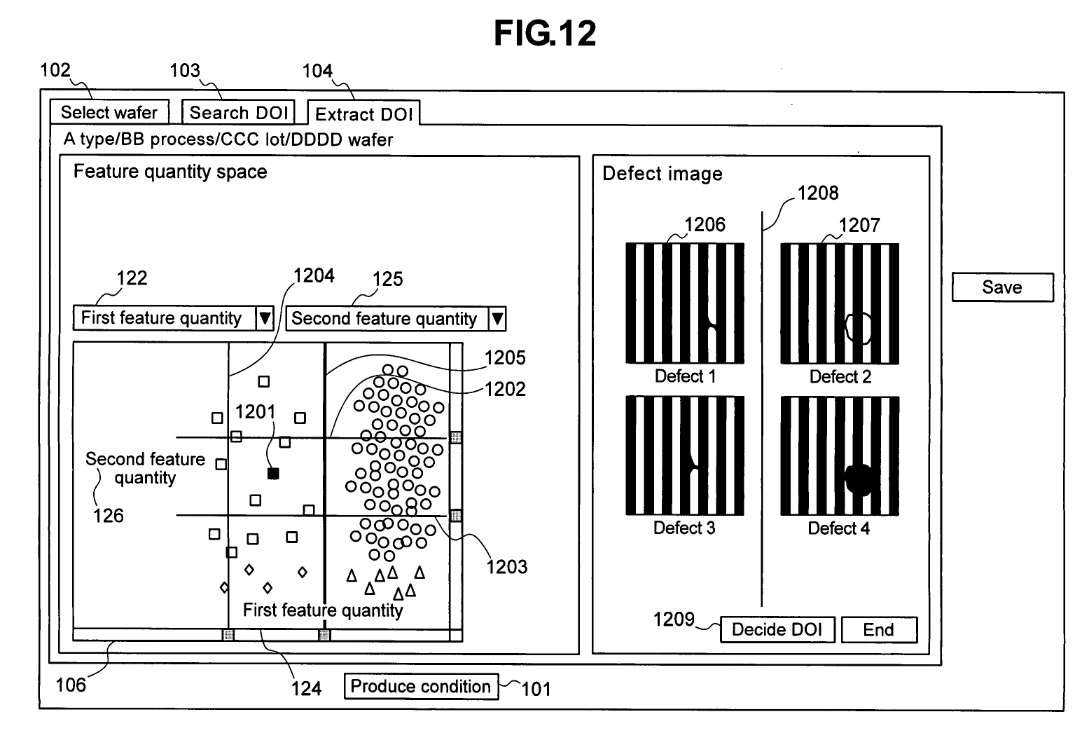

FIG. 12 shows an example of the DOI extract screen. All the defects are plotted in the feature-quantity space diagram 106. There are provided a first feature-quantity button 122 and a second feature-quantity button 125. When the first feature-quantity button 122 is clicked, a feature-quantity select menu 123 is shown. When a feature quantity is selected from the feature-quantity select menu 123, the feature quantity is shown on the horizontal axis 124 in the feature-quantity space diagram 106. In the same way, when the second feature-quantity button 125 is clicked, the feature-quantity select menu 123 is shown.

When a feature quantity is selected from the feature-quantity select menu 123, the feature quantity is shown on the vertical axis 126 of the feature-quantity space diagram 106. Also, the searched DOI 1201 is plotted in the feature-quantity space diagram 106. A boundary line 1 1202, a boundary line 2 1203, a boundary line 3 1204, and a boundary line 4 1205 are shown in the upper, lower, left, and right directions of the searched DOI 1201. Each boundary line is movable in the upper and lower, or left and right directions. When the user clicks and selects one of the boundary lines, an image 1206 of the defect inside and close to the boundary line and an image 1207 of the defect outside and close to the boundary line are shown. In FIG. 12, the boundary line 4 1205 is selected, the image 1206 of the defect inside and close to the boundary line is shown on the left of the boundary line 1208 and the image 1207 of the defect outside and close to the boundary line is shown on the right of the boundary line 1208.

When the user moves the boundary line 4 1205, the defect close to the boundary line changes accordingly. Therefore, the image of the defect shown also changes. The user checks the defects shown, and moves the boundary line 4 1205 so that a defect judged as a DOI is inside the boundary line. This is similarly done with respect to the upper, lower, left, and right boundary lines. Further, as required, the first and second feature quantities are selected again and the above processing is similarly performed. When the above processing has been performed with respect to all the feature quantities, the DOI decide button 1209 is clicked and all the DOIs are confirmed.

Another example of the DOI extract screen is shown. If the wafer reference has been selected during the DOI search, when the DOI extract tab 104 is clicked on the wafer reference screen 2 (FIG. 4), the DOI extract screen 2 is shown.

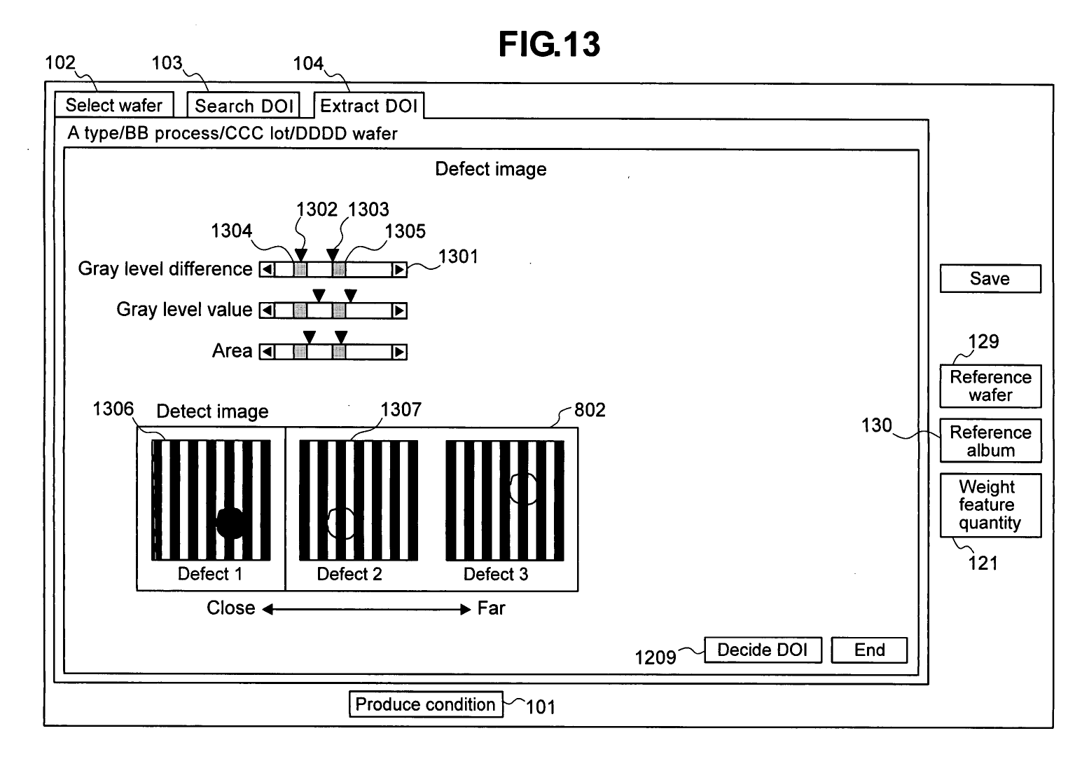

FIG. 13 shows another example of the DOI extract screen. An upper limit 1302 and a lower limit 1303 of the feature quantity with respect to the DOI of the referenced wafer are shown on the feature-quantity display bar 1301. A left cursor 1304 and a right cursor 1305 of the feature-quantity display bar 1301 are movable. When the user clicks and selects one of the cursors of the feature-quantity display bar, an image 1306 of the defect inside and close to the cursor and an image 1307 of the defect outside and close to the cursor are shown. When the user moves the cursor, the defect close to the cursor changes accordingly. Therefore, the image of the defect shown also changes. The user checks the defect shown, and moves the cursor so that the defect judged as a DOI is inside the cursors The same processing is performed with respect to right and left cursors of all the feature quantities. When the above processing has been performed with respect to all the feature quantities, the DOI decide button 1209 is clicked to confirm all the DOIs.

Using the DOI extracted by the above process as instruction data, defect classification is performed based on prescribed classification conditions and the evaluation value of the capability to detect DOIs is calculated. The evaluation value is calculated, for example, by the following expression.
Evaluation value=DOI detection rate−Constant×Nuisance rate

Various conditions such as defect judgment, defect image processing, and defect classification are automatically adjusted by prescribed processing so that the above evaluation value reaches a maximum. Thus, the condition presenting of the inspection is achieved.

FIG. 19 shows an example of prescribed processing for automatically adjusting various conditions. For example, in the image processing 1901, suppose x coordinate 1902 of the image is on the horizontal axis and the brightness difference 1903 is on the vertical axis, and a threshold 1904 is set with respect to the brightness difference 1903. If it is regarded that the area above the threshold 1904 is a defect portion 1905, the range of the x coordinate 1902 of the corresponding image is a feature quantity, which is the size 1906 of the defect. When the threshold value 1904 is changed, the portion corresponding to the defect portion 1905 is changed. Accordingly, the feature quantity, namely, the size 1906 of the defect, which is the range of the x coordinate 1902 of the corresponding image is changed. By this threshold change 1907, the distribution of the defect groups in the feature quantity space 1908 is changed.

In the processing of defect classification 1909, the distribution of the frequency 1917 with respect to the feature quantity selected in the feature quantity selection 1910 is changed by the above threshold change 1907. Accordingly, in the processing of the threshold calculation 1911, the threshold 1914 for differentiation between the DOI 1912 and nuisance 1913 changes. Accordingly, the detection result 1918 of the DOI 1912 and nuisance 1913 is changed. Accordingly, in the evaluation value calculation 1915, the evaluation value 1916 is changed. The above processing is repeatedly and sequentially optimized so that the evaluation value 1916 reaches a maximum.

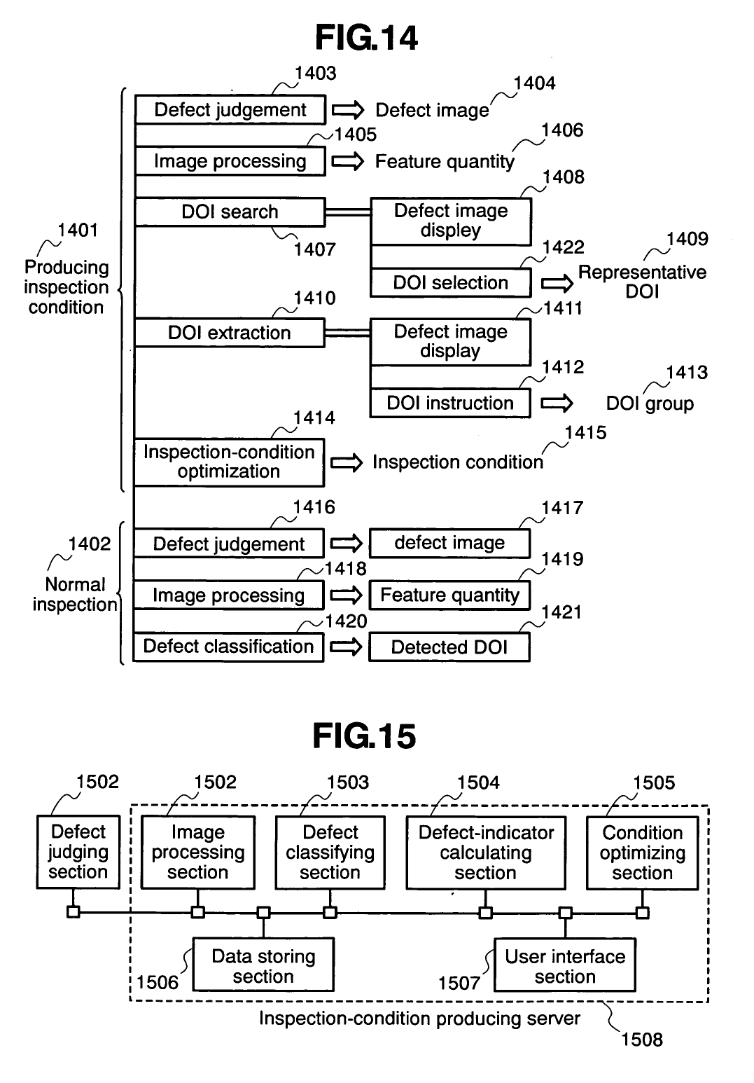

To sum up, an example of the process of the inspection method including the inspection-condition making will be shown in FIG. 14. The whole process comprises two steps of inspection-condition producing 1401 and a normal inspection 1402. In the inspection-condition producing 1401, defect judgment 1403 is performed on a semiconductor wafer to obtain a defect image 1404. The image processing 1405 is performed on the obtained defect image 1404 to extract a feature quantity 1406 of the defect. By using the obtained feature quantity 1406, DOI search 1407 is performed. In the DOI search 1407, defects are divided into groups according to the feature quantity and defect image display 1408 is executed. Then, the user refers to the defect image shown, and selects a representative DOI 1409 in the DOI selection 1422. By using the representative DOI 1409 as a reference, DOI extraction 1410 is performed.

In the DOI extraction 1410, an indicator obtained from the feature quantity with respect to other defects by using the selected representative DOI 1409 as a reference is added and the defect image display 1411 is executed. Then, the user refers to the defect image shown and performs DOI instruction 1412 to obtain a DOI group 1413. The inspection-condition optimization 1414 for calculating the optimum value of each inspection condition for defect judgement, image processing, and defect classification is executed so that the obtained DOI group 1413 may be most properly classified in the defect classification to obtain an optimum inspection condition 1415. In the normal inspection 1402, the obtained inspection condition 1415 is set in an inspection recipe and defect judgment 1416 is performed on a semiconductor wafer to obtain a defect image 1417. Image processing 1418 is performed on the obtained defect image 1417 to extract the feature quantity 1419 of the defect. By executing the defect classification 1420 using the obtained feature quantity 1419, a detected DOI 1421 is obtained.

The best defect-classification result about the subject wafer is obtained when the step of the inspection-condition producing 1401 is over. Therefore, the step of the inspection-condition producing 1401 may be regarded as a procedure for the inspection method.

Further, in the step of the inspection-condition producing 1401, instead of the DOI extraction 1410, the DOI search 1407 may be repeated to select the required number of DOIs.

Further, if there are two or more types of DOIs, the DOI search 1407 and DOI extraction 1410 may be repeated as many times as the number of types of DOIs.

FIG. 15 shows an example of the configuration of the inspection apparatus according to the present invention. The procedure is the one shown in FIG. 14. This inspection apparatus comprises: a defect judging section 1501 judging a defect of a semiconductor wafer and extracting a defect image; an image processing section 1502 processing the image of the defect and extracting its feature quantity; a defect classifying section 1503 calculating the feature quantity and classifying defects; a defect-indicator calculating section 1504 calculating the feature quantity and adding (giving) an indicator to the defect(s); a condition optimizing section 1505 calculating the inspection conditions, feature quantity of the defect, and defect classification to calculate an optimum condition; a data storing section 1506 storing the inspection condition(s), defect image(s), feature quantity of the defect, and defect classification; and a user interface section 1507 to show the defect image and feature quantity of the defect on a screen and to which a user inputs a defect classification instruction and feature quantity designation. Those sections are connected with one another so that the data can be exchanged among them as required. Further, the components other than the defect judging section 1501 may be connected with one another inside the inspection-condition producing server 1508 and connected with the detect judging section 1501 outside the inspection-condition producing server 1508.

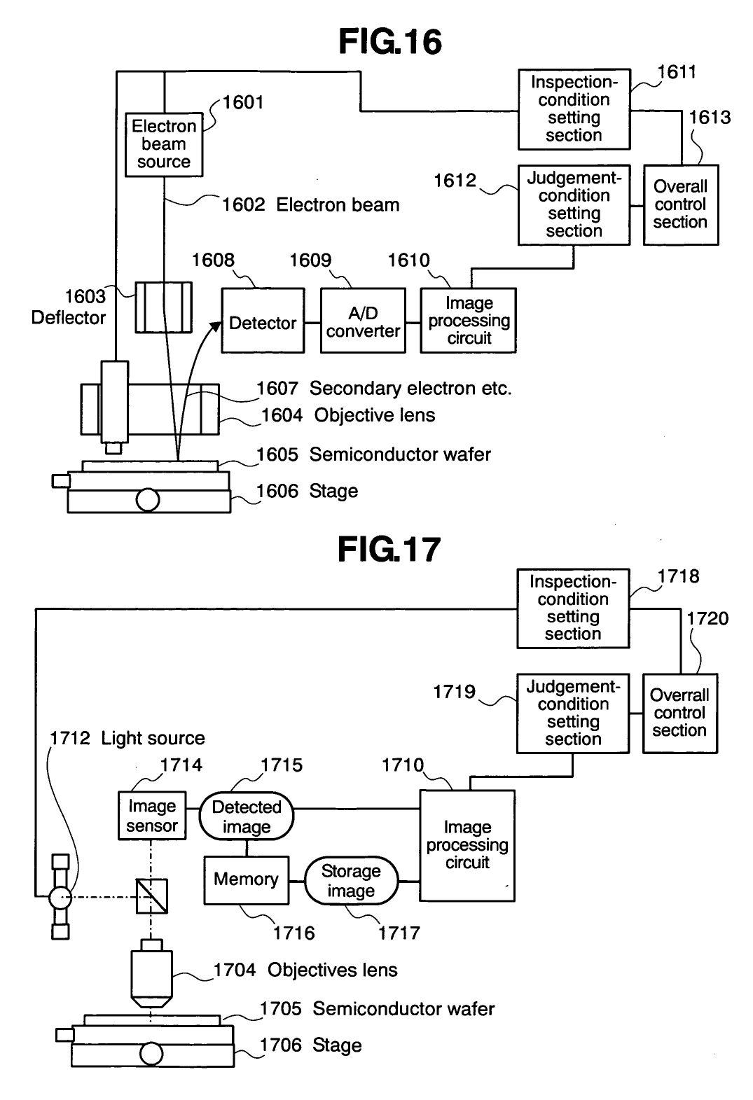

FIG. 16 shows an example of a detailed configuration of the defect judging section 1501. The defect judging section 1501 comprises: an electron beam source 1601 producing electron beams 1602; a deflector 1603 deflecting the electron beams 1602 from the electron beam source 1601 in the x direction; an objective lens 1604 converging the electron beams 1602 to a semiconductor wafer 1605; a stage 1606 moving the semiconductor wafer 1605 in the Y direction upon deflection of the electron beams 1602; a detector 1608 detecting secondary electrons etc. 1607 from the semiconductor wafer 1605; an A/D converter 1609 analog-to-digital converting the detected signals into digital images; an image processing circuit 1610 comprising a plurality of processors comparing the detected digital image with a digital image of a place where the image is expected to be originally the same and judges the place as a defect candidate when a difference is found and electric circuits such as an FPGA; a detection-condition setting section 1611 setting conditions of the portions related to forming images such as the electron beam source 1601, deflector 1602, objective lens 1604, detector 1608, and stage 1606; a judging-condition setting section 1612 setting conditions of judging defects for the image processing circuit; and an overall control section 1613 controlling the whole system.

FIG. 17 shows another example of the detailed configuration of the defect judging section 1501. The defect judging section 1501 comprises: alight source 1712; an objective lens 1704 converging light beams from the light source 1712 to a semiconductor wafer 1705, a stage 1706 moving the semiconductor wafer 1705 in the Y direction; an image sensor 1714 detecting reflected light from the semiconductor wafer 1705 and obtaining an analog-to-digital converted detected image 1715; a memory 1716 storing the detected digital image and outputting the stored image 1717; an image processing circuit 1710 comprising a plurality of processors comparing the detected image 1715 with a stored image 1717 and judges the image as a defect candidate and an electric circuit such as an FPGA; a detection-condition setting section 1718 setting the conditions of the portions related to forming images such as the light source 1712, objective lens 1704, image sensor 1714, and the stage 1706; a judging-condition setting section 1719 for setting conditions of judging defects for the image processing circuit; and an overall control section 1720 for controlling the whole system.

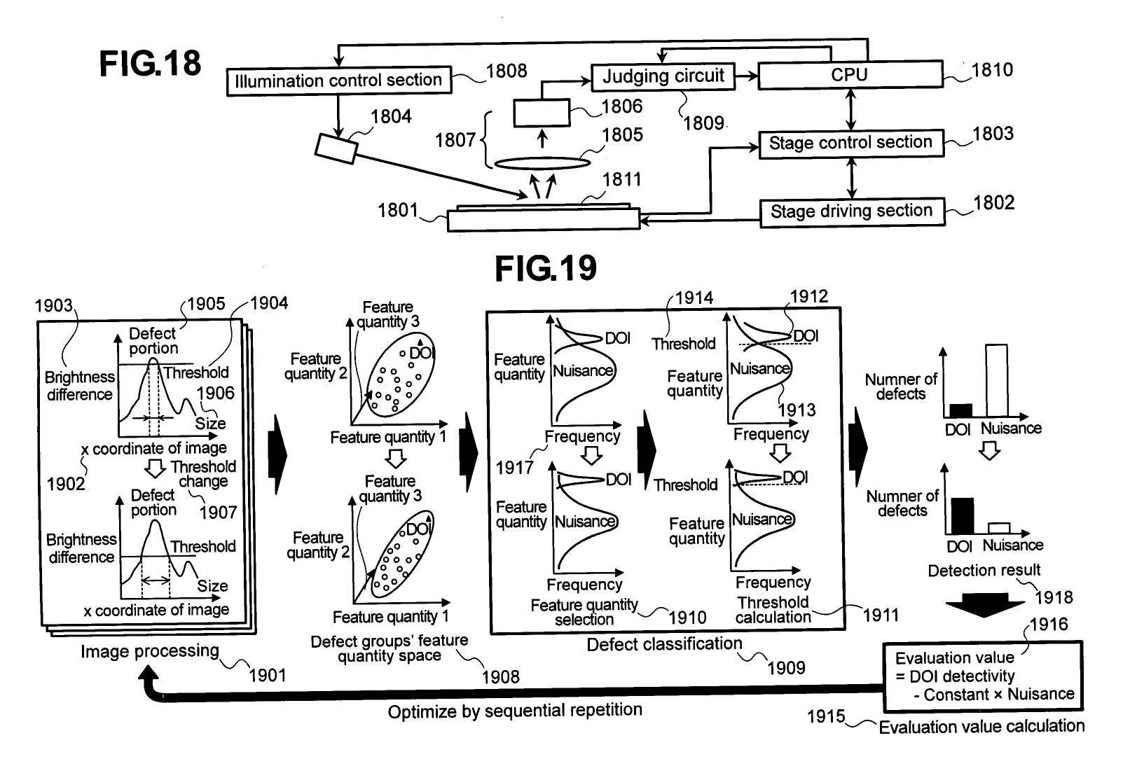

FIG. 18 shows another example of the detailed configuration of the defect judging section 1501. The defect judging section 1501 comprises: a stage 1801 on which a subject 1811 is placed and displacement coordinates of the subject 1811 are measured; a stage driving section 1802 driving the stage 1801; a stage control section 1803 controlling the stage driving section 1802 based on the displacement coordinates of the stage 1801 measured from the stage 1801; an oblique illumination optical system 1804 obliquely illuminating the subject 1811 placed on the stage 1801; a detection optical system 1807 comprising a collective lens 1805 collecting scattered light beams (diffracted light of a lower-order other than zero-order) from the surface of the subject 1811 and a photoelectric converter 1806 comprising a TDI, a CCD sensor, etc.; an illumination control section 1808 controlling amount of light irradiated to the subject 1811 by the oblique illumination optical system 1804, an illuminating angle, etc; a judging circuit (inspection algorithm circuit) 1809 aligning an inspected image signal obtained from the photoelectric converter 1806 and the standard image signal (reference image signal) obtained from a neighboring chip or a cell, comparing the aligned detected-image signal with the reference image signal to extract a difference image, judging the extracted difference image by using a prescribed threshold set in advance to detect an image signal showing a defect, and judging the defect based on the image signal showing the detected defect; and a CPU 1810 performing various processing on the defect judged by the judging circuit 1809 based on a stage coordinate system obtained from the stage control section 1803.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

| | |
|---|---|
| FIG. 1 | |
| 101 | Produce condition |
| 102 | Select wafer |
| 103 | Search DOI |
| 104 | Extract DOI |
| 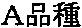 | A type |
| 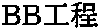 | BB process |
| 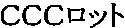 | CCC lot |
| 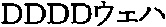 | DDDD wafer |
| 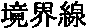 | Boundary line |
| 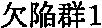 | Defect group 1 |
| 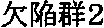 | Defect group 2 |
| 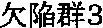 | Defect group 3 |
| 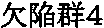 | Defect group 4 |

| | | |
|---|---|---|
| 106 | 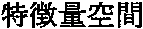 | Feature quantity space |

| | |
|---|---|
| 108 | All |
| 109 | Defect group 1 |
| 110 | Defect group 2 |
| 111 | Defect group 3 |
| 112 | Defect group 4 |
| 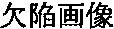 | Defect image |
| 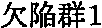 | Defect group 1 |
| 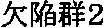 | Defect group 2 |
| 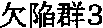 | Defect group 3 |
| 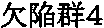 | Defect group 4 |
| 121 | Weight feature quantity |
| 122 | First feature quantity |
| 123 | Feature-quantity select menu |
| 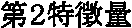 | Second feature quantity |
| 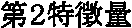 | Second feature quantity |
| 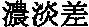 | Gray level difference |
| 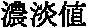 | Gray level value |
| 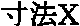 | Size X |
| 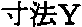 | Size Y |
| 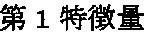 | First feature quantity |
| 125 | Second feature quantity |
| 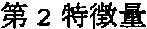 | Second feature quantity |
| 127 | Feature-quantity weighting window |
| 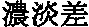 | Gray level difference |
| 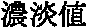 | Gray level value |
| 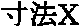 | Size X |
| 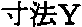 | Size Y |
| 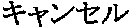 | Cancel |
| 129 | Reference wafer |
| 130 | Reference album |
| 213 | Decide DOI |
| 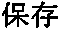 | Save |
| 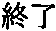 | End |
| FIG. 2 | |
| 101 | Produce condition |
| 102 | Select wafer |
| 103 | Search DOI |
| 104 | Extract DOI |
| 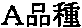 | A type |
| 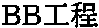 | BB process |
| 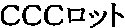 | CCC lot |
| 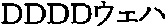 | DDDD wafer |

| | | |
|---|---|---|
| 106 | 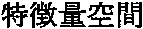 | Feature quantity space |

| | |
|---|---|
| 108 | All |
| 109 | Defect group 1 |
| 110 | Defect group 2 |
| 111 | Defect group 3 |
| 112 | Defect group 4 |
| 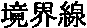 | Boundary line |
| 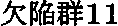 | Defect group 11 |
| 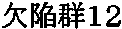 | Defect group 12 |
| 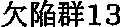 | Defect group 13 |
| 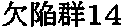 | Defect group 14 |
| 121 | Weight feature quantity |
| 122 | First feature quantity |
| 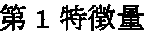 | First feature quantity |
| 125 | Second feature quantity |
| 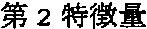 | Second feature quantity |
| 201 | Defect group 11 |
| 202 | Defect group 12 |
| 203 | Defect group 13 |
| 204 | Defect group 14 |
| 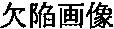 | Defect image |
| 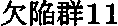 | Defect group 11 |
| 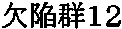 | Defect group 12 |
| 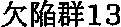 | Defect group 13 |
| 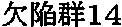 | Defect group 14 |
| 213 | Decide DOI |
| 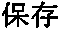 | Save |
| 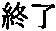 | End |
| FIG. 3 | |
| 101 | Produce condition |
| 102 | Select wafer |
| 103 | Search DOI |
| 104 | Extract DOI |
| 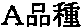 | A type |
| 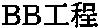 | BB process |
| 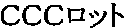 | CCC lot |
| 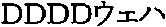 | DDDD wafer |

| | | |
|---|---|---|
| 106 | 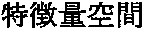 | Feature quantity space |

| | |
|---|---|
| 108 | All |
| 109 | Defect group 1 |
| 110 | Defect group 2 |
| 111 | Defect group 3 |
| 112 | Defect group 4 |
| 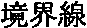 | Boundary line |
| 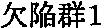 | Defect group 1 |
| 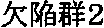 | Defect group 2 |
| 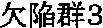 | Defect group 3 |
| 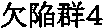 | Defect group 4 |
| 121 | Weight feature quantity |
| 122 | First feature quantity |
| 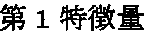 | First feature quantity |
| 125 | Second feature quantity |
| 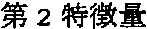 | Second feature quantity |
| 129 | Reference wafer |
| 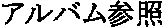 | Reference album |
| 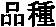 | Type |
| 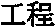 | Process |
| 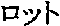 | Lot |
| 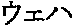 | Wafer |
| 903 | Open |
| 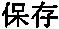 | Save |
| FIG. 4 | |
| 101 | Produce condition |
| 102 | Select wafer |
| 103 | Search DOI |
| 104 | Extract DOI |
| 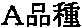 | A type |
| 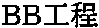 | BB process |
| 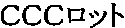 | CCC lot |
| 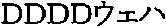 | DDDD wafer |
| 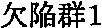 | Defect group 1 |
| 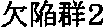 | Defect group 2 |
| 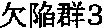 | Defect group 3 |
| 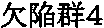 | Defect group 4 |

| | | |
|---|---|---|
| 106 | 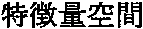 | Feature quantity space |

| | |
|---|---|
| 108 | All |
| 109 | Defect group 1 |
| 110 | Defect group 2 |
| 111 | Defect group 3 |
| 112 | Defect group 4 |
| 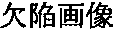 | Defect image |
| 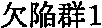 | Defect group 1 |
| 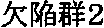 | Defect group 2 |
| 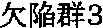 | Defect group 3 |
| 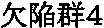 | Defect group 4 |
| 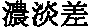 | Gray level difference |
| 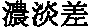 | Gray level difference |
| 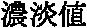 | Gray level value |
| 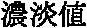 | Gray level value |
| 121 | weight feature quantity |
| 129 | Reference wafer |
| 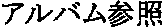 | Reference album |
| 213 | Decide DOI |
| 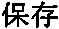 | Save |
| 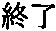 | End |
| FIG. 5 | |
| 101 | Produce condition |
| 102 | Select wafer |
| 103 | Search DOI |
| 104 | Extract DOI |
| 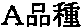 | A type |
| 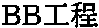 | BB process |
| 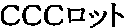 | CCC lot |
| 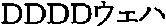 | DDDD wafer |

| | | |
|---|---|---|
| 106 | 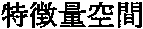 | Feature quantity space |

| | |
|---|---|
| 108 | All |
| 109 | Defect group 1 |
| 110 | Defect group 2 |
| 111 | Defect group 3 |
| 112 | Defect group 4 |
| 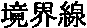 | Boundary line |
| 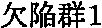 | Defect group 1 |
| 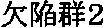 | Defect group 2 |
| 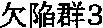 | Defect group 3 |
| 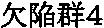 | Defect group 4 |
| 121 | Weight feature quantity |
| 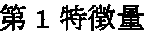 | First feature quantity |
| 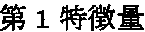 | First feature quantity |
| 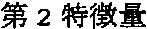 | Second feature quantity |
| 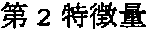 | Second feature quantity |
| 129 | Reference wafer |
| 130 | Reference album |
| 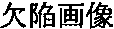 | Defect image |
| 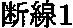 | Broken wire 1 |
| 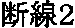 | Broken wire 2 |
| 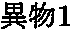 | Foreign material 1 |
| 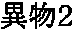 | Foreign material 2 |
| 503 | Select defect |
| 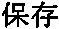 | Save |
| 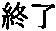 | End |
| FIG. 6 | |
| 101 | Produce condition |
| 102 | Select wafer |
| 103 | Search DOI |
| 104 | Extract DOI |
| 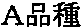 | A type |
| 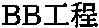 | BB process |
| 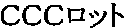 | CCC lot |
| 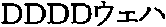 | DDDD wafer |

| | | |
|---|---|---|
| 106 | 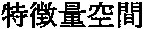 | Feature quantity space |

| | |
|---|---|
| 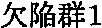 | Defect group 1 |
| 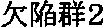 | Defect group 2 |
| 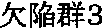 | Defect group 3 |
| 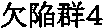 | Defect group 4 |
| 121 | weight feature quantity |
| 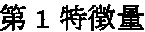 | First feature quantity |
| 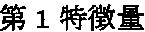 | First feature quantity |
| 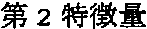 | Second feature quantity |
| 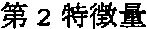 | Second feature quantity |
| 129 | Reference wafer |
| 130 | Reference album |
| 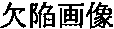 | Defect image |
| 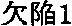 | Defect 1 |
| 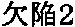 | Defect 2 |
| 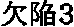 | Defect 3 |
| 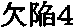 | Defect 4 |
| 213 | Decide DOI |
| 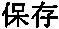 | Save |
| 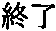 | End |
| FIG. 7 | |
| 101 | Produce condition |
| 102 | Select wafer |
| 103 | Search DOI |
| 104 | Extract DOI |
| 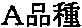 | A type |
| 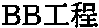 | BB process |
| 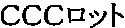 | CCC lot |
| 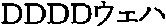 | DDDD wafer |
| 121 | Weight feature quantity |
| 129 | Reference wafer |
| 130 | Reference album |
| 213 | Decide DOI |
| 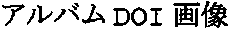 | Album DOI image |
| 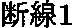 | Broken wire 1 |
| 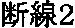 | Broken wire 2 |
| 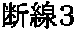 | Broken wire 3 |
| 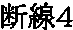 | Broken wire 4 |
| 503 | Select defect |
| 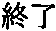 | End |
| 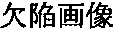 | Defect image |
| 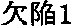 | Defect 1 |
| 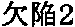 | Defect 2 |
| 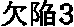 | Defect 3 |
| 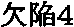 | Defect 4 |
| 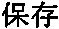 | Save |
| 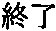 | End |
| FIG. 8 | |
| 101 | Produce condition |
| 102 | Select wafer |
| 103 | Search DOI |
| 104 | Extract DOI |
| 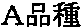 | A type |
| 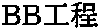 | BB process |
| 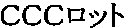 | CCC lot |
| 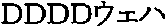 | DDDD wafer |
| 121 | Weight feature quantity |
| 129 | Reference wafer |
| 130 | Reference album |
| 213 | Decide DOI |
| 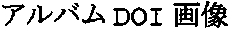 | Album DOI image |
| 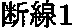 | Broken wire 1 |
| 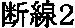 | Broken wire 2 |
| 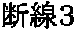 | Broken wire 3 |
| 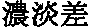 | Gray level difference |
| 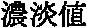 | Gray level value |
| 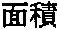 | Area |
| 503 | Select defect |
| 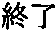 | End |
| 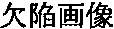 | Defect image |
| 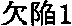 | Defect 1 |
| 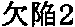 | Defect 2 |
| 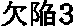 | Defect 3 |
| 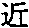 | Close |
| 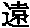 | Far |
| 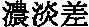 | Gray level difference |
| 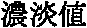 | Gray level value |
| 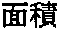 | Area |
| 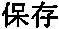 | Save |
| 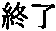 | End |
| FIG. 9 | |
| 101 | Produce condition |
| 103 | Search DOI |
| 903 | Open |
| 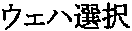 | Select wafer |
| 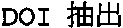 | Extract DOI |
| 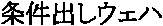 | Wafer for which condition is produced |
| 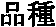 | Type |
| 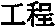 | Process |
| 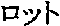 | Lot |
| 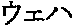 | Wafer |
| 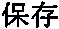 | Save |
| FIG. 10 | |

| | | |
|---|---|---|
| 1001 | 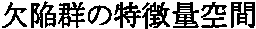 | Defect groups' feature quantity space |

| | |
|---|---|
| 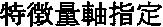 | Define feature quantity axis |
| 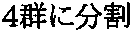 | Divide into four groups |
| 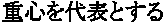 | Regard barycenter as representative |
| 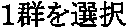 | Select one group |
| 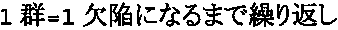 | Repeat until 1 group = 1 defect |
| 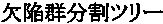 | Defect-group division tree |
| 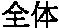 | All |
| 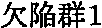 | Defect group 1 |
| 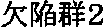 | Defect group 2 |
| 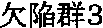 | Defect group 3 |
| 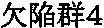 | Defect group 4 |
| 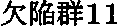 | Defect group 11 |
| 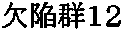 | Defect group 12 |
| 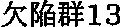 | Defect group 13 |
| 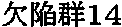 | Defect group 14 |
| 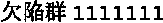 | Defect group 1111111 |
| 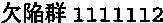 | Defect group 1111112 |
| 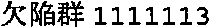 | Defect group 1111113 |
| 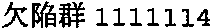 | Defect group 1111114 |
| 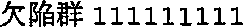 | Defect group 111111111 |
| 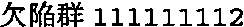 | Defect group 111111112 |
| 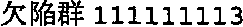 | Defect group 111111113 |
| 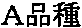 | Defect group 111111114 |
| FIG. 11 | |

| | | |
|---|---|---|
| 1001 | 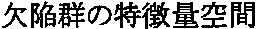 | Defect groups' feature quantity space |

| | |
|---|---|
| 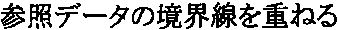 | Superimpose boundary lines of reference data |
| 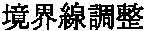 | Adjust boundary line |
| 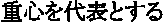 | Regard barycenter as representative |
| 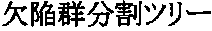 | Defect-group division tree |
| 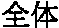 | All |
| 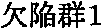 | Defect group 1 |
| 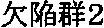 | Defect group 2 |
| 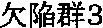 | Defect group 3 |
| 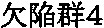 | Defect group 4 |
| FIG. 12 | |
| 101 | Produce condition |
| 102 | Select wafer |
| 103 | Search DOI |
| 104 | Extract DOI |
| 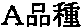 | A type |
| 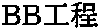 | BB process |
| 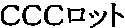 | CCC lot |
| 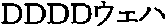 | DDDD wafer |

| | | |
|---|---|---|
| 106 | 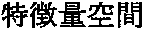 | Feature quantity space |

| | |
|---|---|
| 122 | First feature quantity |
| 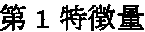 | First feature quantity |
| 125 | Second feature quantity |
| 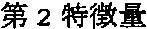 | Second feature quantity |
| 1209 | Decide DOI |
| 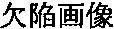 | Defect image |
| 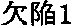 | Defect 1 |
| 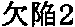 | Defect 2 |
| 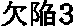 | Defect 3 |
| 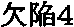 | Defect 4 |
| 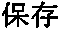 | Save |
| 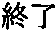 | End |
| FIG. 13 | |
| 101 | Produce condition |
| 102 | Select wafer |
| 103 | Search DOI |
| 104 | Extract DOI |
| 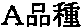 | A type |
| 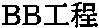 | BB process |
| 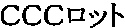 | CCC lot |
| 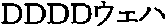 | DDDD wafer |
| 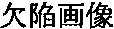 | Defect image |
| 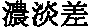 | Gray level difference |
| 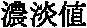 | Gray level value |
| 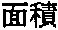 | Area |
| 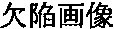 | Defect image |
| 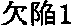 | Defect 1 |
| 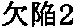 | Defect 2 |
| 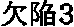 | Defect 3 |
| 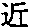 | Close |
| 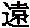 | Far |
| 121 | Weight feature quantity |
| 129 | Reference wafer |
| 130 | Reference album |
| 1209 | Decide DOI |
| 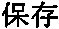 | Save |
| 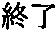 | End |
| FIG. 14 | |
| 1401 | Producing inspection condition |
| 1402 | Normal inspection |
| 1403 | Defect judgment |
| 1404 | Defect image |
| 1405 | Image processing |
| 1406 | Feature quantity |
| 1407 | DOI search |
| 1408 | Defect image display |
| 1409 | Representative DOI |
| 1410 | DOI extraction |
| 1411 | Defect image display |
| 1412 | DOI instruction |
| 1413 | DOI group |
| 1414 | Inspection-condition optimization |
| 1415 | Inspection condition |
| 1416 | Defect judgment |
| 1417 | defect image |
| 1418 | Image processing |
| 1419 | Feature quantity |
| 1420 | Defect classification |
| 1421 | Detected DOI |
| 1422 | DOI selection |
| FIG. 15 | |
| 1501 | Defect judging section |
| 1502 | Image processing section |
| 1503 | Defect classifying section |
| 1504 | Defect-indicator calculating section |
| 1505 | Condition optimizing section |
| 1506 | Data storing section |
| 1507 | User interface section |
| 1508 | Inspection-condition producing server |
| FIG. 16 | |
| 1601 | Electron beam source |
| 1602 | Electron beam |
| 1603 | Deflector |
| 1604 | Objective lens |
| 1605 | Semiconductor wafer |
| 1606 | Stage |
| 1607 | Secondary electron etc. |
| 1608 | Detector |
| 1609 | A/D converter |
| 1610 | Image processing circuit |
| 1611 | Inspection-condition setting section |
| 1612 | Judgment-condition setting section |
| 1613 | Overall control section |
| FIG. 17 | |
| 1704 | Objective lens |
| 1705 | Semiconductor wafer |
| 1706 | Stage |
| 1710 | Image processing circuit |
| 1712 | Light source |
| 1714 | Image sensor |
| 1715 | Detected image |
| 1716 | Memory |
| 1717 | Stored image |
| 1718 | Inspection-condition setting section |
| 1719 | Judgment-condition setting section |
| 1720 | Overall control section |
| FIG. 18 | |
| 1802 | Stage driving section |
| 1803 | Stage control section |
| 1808 | Illumination control section |
| 1809 | Judging circuit |
| FIG. 19 | |
| 1901 | Image processing |
| 1902 | x coordinate of image |
| 1903 | Brightness difference |
| 1904 | Threshold |
| 1905 | Defect portion |
| 1906 | Size |
| 1907 | Threshold change |
| 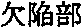 | Defect portion |
| 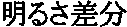 | Brightness difference |
| 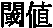 | Threshold |
| 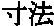 | Size |
| 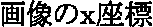 | x coordinate of image |
| 1908 | Defect groups' feature quantity space |
| 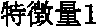 | Feature quantity 1 |
| 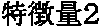 | Feature quantity 2 |
| 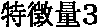 | Feature quantity 3 |
| 1909 | Defect classification |
| 1910 | Feature quantity selection |
| 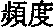 | Frequency |
| 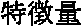 | Feature quantity |
| 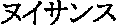 | Nuisance |
| 1911 | Threshold calculation |
| 1913 | Nuisance |
| 1914 | Threshold |
| 1917 | Frequency |
| 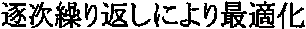 | Optimize by sequential repetition |
| 1915 | Evaluation value calculation |
| 1916 | Evaluation value = DOI detectivity − |
| | Constant × Nuisance rate |
| 1918 | Detection result |
| 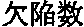 | Number of defects |

What is claimed is:

1. A method for inspecting samples, comprising the steps of:
inspecting a sample;
showing images of defects inspected and detected on a screen;
designating a defect of interest among the shown defects;
extracting a defect having a feature quantity similar to that of the designated defect of interest from said images of detected defects;
showing images of the extracted defects on said screen;
instructing a defect similar to said designated defect of interest among the shown images of the defects;
setting a defect inspection condition based on the instructed information; and
inspecting the sample based on the inspection condition thus set.

2. A method for inspecting samples according to claim 1, wherein a plurality of feature quantities of said defects inspected and detected are weighted and classified, and the result of the classification is shown on said screen.

3. A method for inspecting samples according to claim 1, wherein information about the classification of said defects inspected and detected and an image of a representative defect among the classified defects are shown on said screen.

4. A method for inspecting samples, comprising the steps of:
inspecting a sample;
classifying the inspected and detected defects according to their feature quantities and showing the result on a screen;
designating a defect of interest among the shown defects;
correcting the classification of said defects based on the feature quantity of the designated defect of interest and showing it on said screen;
correcting the classification of the defects, whose classification has been corrected and shown, on said screen;
classifying said defects again based on the classification corrected on the screen;
setting a defect inspection condition based on information about the reclassification; and
inspecting the sample based on the inspection condition thus set.

5. A method for inspecting samples according to claim 4, wherein a plurality of feature quantities of said defects inspected and detected are weighted and classified, and the result of the classification is shown on said screen.

6. A method for inspecting samples according to claim 4, wherein information about the classification of said defects inspected and defected and an image of a representative defect among the classified defects are shown on said screen.

7. An apparatus for inspecting samples, comprising:
inspecting means for inspecting a sample;
displaying means for showing images of defects inspected and detected by the inspecting means on a screen;
designating means for designating a defect of interest among the defects shown below the displaying means;
extracting means for extracting a defect having a feature quantity similar to that of the designated defect of interest from said images of detected defects and showing it on said screen;
instructing means for instructing a defect similar to said designated defect of interest among the images of defects extracted by the extracting means and shown on said screen;
inspection-condition setting means for setting a defect inspection condition based on the information instructed by the instructing means;
defect detecting means for inspecting the sample by using said inspecting means based on the inspection condition set by the inspection-condition setting means, and detecting a defect similar to the defect of interest designated by said designation means from among the detected defects.

8. An apparatus for inspecting samples according to claim 7, wherein said displaying means weights a plurality of feature quantities of the defects inspected and detected by said inspecting means, classifies them, and shows the result on a screen.

9. An apparatus for inspecting samples according to claim 7, wherein said displaying means shows information about the classification of defects inspected and detected by said inspecting means and an image of a representative defect among the classified defects side by side on said screen.

10. An apparatus for inspecting samples according to claim 7, wherein said classification correcting means enters correction information of the defect classification on said screen where said corrected classification information is shown.

11. An apparatus for inspecting samples according to claim 7, wherein said displaying means shows images of the defects inspected and detected by said inspecting means and images classified and stored in advance side by side.

12. An apparatus for inspecting samples, comprising:
inspecting means for inspecting a sample;
defect classifying means for classifying defects inspected and detected by the inspecting means based on the feature quantities of the defects;
displaying means for showing defects classified by the defect classifying means on a screen;
defect-of-interest designating means for designating a defect of interest among the defects shown on the screen of the displaying means;
correcting means for correcting the classification of said defects based on a feature quantity of the defect of interest designated by the defect-of-interest designating means and showing the result on said screen;
classification correcting means for further correcting the classification of the defects whose classification has been corrected by the correcting means and shown;
inspection-condition setting means for setting defect inspection conditions based on classification information corrected by the classification correcting means; and
defect detecting means for inspecting the sample by using said inspecting means based on the inspection condition set by the inspection-condition setting means and detecting a defect similar to the defect of interest designated by said defect-of-interest designating means from among the detected defects.

13. An apparatus for inspecting samples according to claim 12, wherein said defect classifying means classifies defects detected by said inspecting means by weighting a plurality of feature quantities of the defects.

14. An apparatus for inspecting samples according to claim 12, wherein said displaying means shows information about the classification of the defects inspected and detected by said inspecting means and an image of a representative defect among defects classified by the defect classifying means side by side on said screen.

15. An apparatus for inspecting samples according to claim 12, wherein said classification correcting means enters correction information of the defect classification on said screen where said corrected classification information is shown.

16. An apparatus for inspecting samples according to claim 12, wherein said displaying means shows images of the defects inspected and detected by said inspecting means and images classified and stored in advance side by side.

17. An apparatus for inspecting samples, comprising;
imaging means for imaging a sample;
image processing means for processing an image of said sample imaged by the imaging means;
detection-condition setting means for setting a detection condition for detecting a defect of interest based on the image of said sample processed by the image processing means; and
defect detecting means for processing the image of said sample processed by said image processing means based on the detection condition set by the detection-condition setting means and detecting a defect on said sample.

18. An apparatus for inspecting samples according to claim 17, wherein said detection-condition setting means has a display screen on which the image of said sample processed by said image processing means is shown and corrects the detection condition for detecting said defect of interest on the display screen.
